(19) United States
(12) Patent Application Publication
(10) Pub. No.: US 2012/0044060 A1
(43) Pub. Date: Feb. 23, 2012

(54) Electronic Device And Data Management System

(75) Inventors: Yoshihiro Matsubara, Nagano-ken (JP); Haruyoshi Ohori, Nagano-ken (JP)

(73) Assignee: SEIKO EPSON CORPORATION, Tokyo (JP)

(21) Appl. No.: 13/194,660

(22) Filed: Jul. 29, 2011

(30) Foreign Application Priority Data
Aug. 17, 2010 (JP) 2010-182118

(51) Int. Cl. G06K 7/01

(52) U.S. Cl. 340/10.51

(57) ABSTRACT

Efficiently processing information related to the warranty of an electronic device is enabled. A receipt printer 10 has an RFID tag 27 that can contactlessly read and write information by means of wireless communication with an external data processing terminal is disposed in the case, and the data processing terminal can read and write product warranty related data to the RFID tag 27.

### BACKGROUND

1. Technical Field

The present invention relates to an electronic device that is transported stored in packaging material, and to a data management system using the electronic device.

2. Related Art

POS systems are commonly deployed in supermarkets and other retail stores. See, for example, Japanese Unexamined Patent Appl. Pub. JP-A-2010-86022. Numerous electronic devices such as receipt printers and electronic cash drawers are typically used to assemble a POS system.

The required electronic devices are shipped from the manufacturer of the electronic devices to the user that will construct the POS system (which, for example, may be another department of the device manufacturer that is responsible for system installation, or a third-party systems integrator that specializes in POS system installation; referred to below as the “system integrator”) after the devices are packed in dedicated packaging. The system integrator transports the electronic devices to the store where the POS system is to be installed, sets up and configures the electronic devices appropriately, and thus installs the POS system.

A warranty card containing information such as the warranty period is normally provided with the electronic devices that are shipped from the device manufacturer to the system integrator. The warranty card is typically contained in the same packaging that holds the electronic device in order to clearly identify the product to which it applies and to reduce the risk of loss. After opening the packaging containing each electronic device, the system integrator removes the warranty card from the packaging and records essential information on the warranty card, such as the date the warranty period of the electronic device starts (such as the date the electronic device was actually delivered to the store) and the name of the on-site installer, and then puts the warranty card back in the packaging.

A problem with this is that when many electronic devices are required to construct the POS system, the workload of the system integrator increases dramatically. In addition, this method requires the system integrator to open each package, and some businesses do not want the packaging to be opened due to a desire to reliably maintain the integrity of each electronic device.

### SUMMARY

The invention enables efficiently processing information related to the warranty of an electronic device that is stored in packaging without opening the packaging.

A first aspect of the invention is an electronic device having a contactless tag that can contactlessly read and write information by means of wireless communication with an external data processing terminal disposed in the case of the electronic device. The electronic device is contained in packaging; and the data processing terminal can read and write product warranty related data to the contactless tag from outside the packaging.

This aspect of the invention enables using the contactless tag to function as a warranty card by recording the same information that is recorded on a conventional paper warranty card in the contactless tag. Because the warranty related information can be written to the contactless tag by the data processing terminal, warranty related information can be processed more efficiently than when the required information is manually written on a conventional paper warranty card.

In an electronic device according to another aspect of the invention, the electronic device is shipped in the packaging; and a mark that is visible from the outside is recorded on the packaging at a position corresponding to the location of an antenna of the contactless tag in the case.

Because the warranty related information can be written to the contactless tag from outside the packaging with this aspect of the invention, there is no need to break the seal of the package containing the electronic device in order to remove and complete the warranty card. In addition, because the location of the contactless tag antenna can be determined from outside the packaging, the data processing terminal and contactless tag can reliably be made to communicate wirelessly.

In an electronic device according to another aspect of the invention, overwriting the product warranty related data that is written to the contactless tag is protected by a password.

This aspect of the invention can prevent product warranty related information written to the contact less tag from being illegally overwritten, and by writing the warranty related information to the contactless tag, the reliability of the data content can be assured when the contactless tag functions as a warranty card.

In an electronic device according to another aspect of the invention, information related to the product warranty can be reported based on the product warranty related data written to the contactless tag.

The user can therefore know the information written to the contactless tag as needed, thus improving user convenience, because the product warranty related information can be retrieved from the contactless tag and reported.

In an electronic device according to another aspect of the invention, the product warranty related data written to the contact less tag includes at least information related to a warranty period; and the electronic device can report that the end of the warranty period is near or that the warranty period has ended based on the information related to the warranty period.

This aspect of the invention enables automatically reporting when the end of the warranty period is near or that the warranty period has ended, the user can therefore know when the end of the warranty period is near or that the warranty period has ended, and user convenience is thus improved.

In an electronic device according to another aspect of the invention, the contactless tag can communicate with the data processing terminal by means of short-range wireless communication conforming to a Near Field Communication standard.

NFC is a near field communication standard adopted by international standards organizations as a next-generation communication standard, and is widely compatible with other short-range communication technologies that are already in widespread use. Devices capable of short-range communication conforming to NFC standards are expected to become increasingly common.

Therefore, by rendering the contactless tag capable of short-range wireless communication conforming to an NFC standard, particularly good usability and convenience can be achieved both now and in the future, and warranty related information can be processed using a contactless tag.

Another aspect of the invention is a data management system including: an electronic device having a contactless tag disposed in the case of the electronic device; a data processing terminal that can read and write information in the contactless tag disposed to the electronic device; and a server device connected to the data processing terminal by a communication channel; wherein the data processing terminal reads and writes product warranty related data to the contactless tag, and sends data read from the contactless tag to the server device; and the server device stores information received from the data processing terminal.

This aspect of the invention enables using the contactless tag to function as a warranty card by recording the same information that is recorded on a conventional paper warranty card in the contactless tag. Because the warranty related information can be written to the contactless tag by the data processing terminal, warranty related information can be processed more efficiently than when the required information is manually written on a conventional paper warranty card.

In addition, because product warranty related information is sent from an external data processing terminal to the server and the server stores the information, the server can centrally manage product warranty related information for each individual electronic device.

### Effect of the Invention

The invention enables efficiently processing information related to the warranty of an electronic device without opening the packaging when the electronic device is stored in packaging.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows the configuration of a data management system.

FIG. 2 is a block diagram showing the functional configuration of a receipt printer.

FIG. 3 is a list of data stored in flash memory.

FIG. 4 is an oblique view of a package.

FIG. 5 is a block diagram showing the functional configuration of cell phone with a read/write function.

FIG. 6 shows a data input screen.

FIG. 7 is a list of data stored in flash memory.

FIG. 8 shows the data fields in each record of the receipt printer management database.

FIG. 9 is a flow chart of receipt printer operation.

FIG. 10 is a list of data stored in flash memory.

### DESCRIPTION OF EMBODIMENTS

A preferred embodiment of the present invention is described below with reference to the accompanying figures.

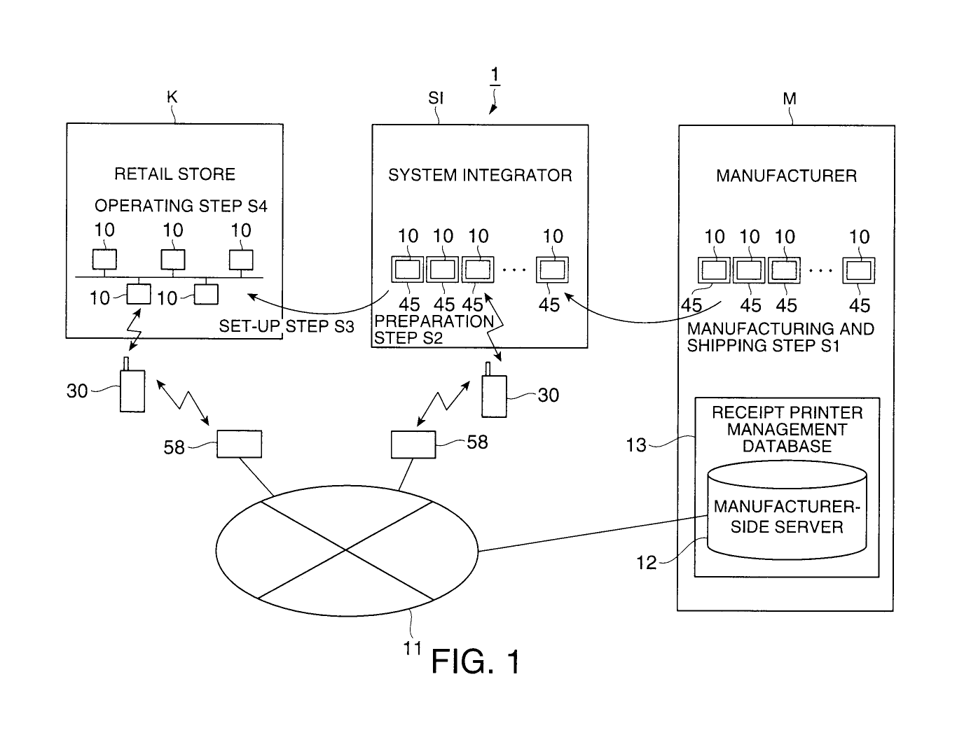

FIG. 1 shows the configuration of a data management system 1 according to a preferred embodiment of the invention.

The invention is described below using by way of example a case in which a retail store K such as a supermarket or department store has installed the infrastructure for installing a POS system, and in order to construct the POS system installs plural (fifty in this example) receipt printers 10 (electronic devices) for printing receipts. The receipt printers 10 are an example of a physical component of the POS system.

As known from the literature, building the environment required for a POS system requires, in addition to receipt printers 10, electronic cash drawers and devices used with the electronic cash drawers such as barcode readers installed at each checkout register in the retail store K, and a server for managing sales transactions and product inventory. To more clearly describe the invention, however, this embodiment describes introducing receipt printers 10 to the retail store K.

The manufacturer M in this embodiment of the invention is the manufacturer of the receipt printers 10, and the system integrator SI is an organization other than the manufacturer M that actually constructs the POS system in the retail store K.

The manufacturing and shipping step S1 in which the manufacturer M manufactures the receipt printers 10 and ships the receipt printers 10 to the system integrator SI is described first.

As described above, the manufacturer M is the organization that manufactures the receipt printers 10, and maintains a manufacturer-side server 12 (server computer) that can be externally accessed over a communication network 11 (communication line). The manufacturer-side server 12 administers a receipt printer management database 13. The manufacturer-side server 12 and the receipt printer management database 13 are further described below.

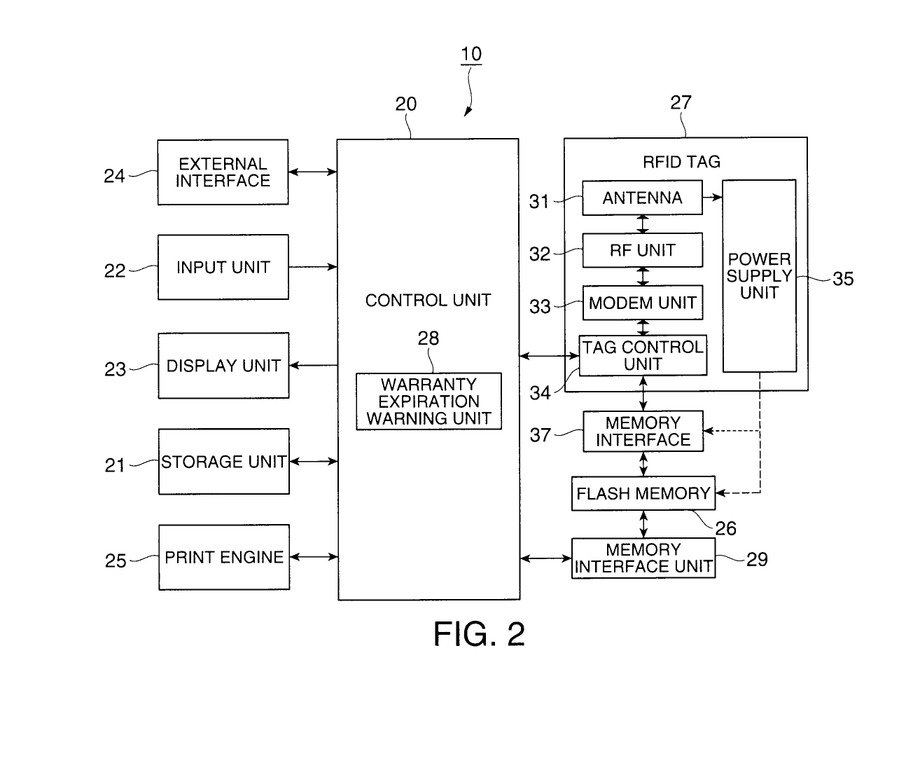

FIG. 2 is a block diagram showing the functions of the receipt printers 10 manufactured by the manufacturer M.

The receipt printers 10 according to this embodiment of the invention are connected to an external device such as a host computer, print images on roll paper, and cut the roll paper to a specific length as controlled by the external device to issue receipts. As shown in FIG. 2, each receipt printer 10 includes a control unit 20, a storage unit 21, an input unit 22, a display unit 23, an external interface 24, a print engine 25, flash memory 26 (memory), and an RFID tag 27.

The control unit 20 centrally controls the operation of other parts of the receipt printer 10, and includes a CPU, ROM, RAM, and other peripheral circuits. A real-time clock (RTC, not shown) is connected to the control unit 20, and the control unit 20 can detect the current date (including the date and time) based on input from the RTC. The control unit 20 also includes a warranty expiration warning unit 28 as described below.

The storage unit 21 is a rewritable, nonvolatile storage device, and stores data as controlled by the control unit 20.

The input unit 22 is connected to an operating switch disposed to the receipt printer 10, detects operation of the operating switch, and outputs the result as an operation signal to the control unit 20.

The display unit 23 has a display panel such as an LCD panel, and displays information on the display panel as controlled by the control unit 20.

The external interface 24 handles communication with a connected external device according to a communication standard as controlled by the control unit 20.

The print engine 25 controls the print mechanism of the receipt printer 10 and prints on roll paper based on print data and commands sent from the connected external device as controlled by the control unit 20. More specifically, the receipt printer 10 has a print mechanism including a printhead that applies heat to the printing surface of the roll paper, a printhead drive mechanism that causes the printhead to move relative to the roll paper, and a transportation mechanism that conveys the roll paper, and the print mechanism is controlled by the print engine 25.

The flash memory 26 is nonvolatile semiconductor memory. The control unit 20 reads and writes data to the control unit 20 through a memory interface unit 29.

The RFID tag 27 is a contactless passive tag capable of wireless short-range communication conforming to a NFC (Near Field Communication) standard with the read/write-capable cell phone 30 (data processing terminal) described below.

NFC is a near field communication standard adopted by international standards organizations as a next-generation communication standard, and is widely compatible with other short-range communication technologies that are already in widespread use. Devices capable of short-range communication conforming to NFC standards are expected to become increasingly common. Therefore, by using a contactless tag conforming to an NFC standard as the RFID tag 27, particularly good usability and convenience can be achieved both now and in the future, and various processes that use RFID tags 27 can be performed.

As shown in FIG. 2, the RFID tag 27 includes an antenna 31, RF unit 32, modem unit 33, tag control unit 34, and power supply unit 35.

The antenna 31 functions as an antenna for sending and receiving data.

The RF unit 32 communicates data through the antenna 31 with the read/write-capable cell phone 30 described below. During data transmission, the RF unit 32 sends the transmitted data as radio signals through the antenna 31 to the read/write-capable cell phone 30. When receiving data, the RF unit 32 receives signals from the read/write-capable cell phone 30 through the antenna 31, and outputs the received signals to the modem unit 33.

The modem unit 33 modulates and demodulates the communication data, and during transmission modulates and outputs the transmitted data to the RF unit 32. When receiving data, the modem unit 33 demodulates the received data based on the signals received from the RF unit 32, and outputs to the tag control unit 34.

The tag control unit 34 centrally controls RFID tag 27 operation. During data transmission, the tag control unit 34 encodes the transmission data and outputs the encoded data to the modem unit 33. During data reception, the tag control unit 34 decodes the reception data input from the modem unit 33. The tag control unit 34 can output the decoded reception data to the control unit 20, and can write the data to flash memory 26 through a memory interface 37. The tag control unit 34 can also read data from the flash memory 26 through the memory interface 37.

The power supply unit 35 has a rectifying circuit not shown, and supplies power to the parts of the RFID tag 27 using a carrier wave for transmitting power received from the read/write-capable cell phone 30 through the antenna 31. When the receipt printer 10 power is off, the power supply unit 35 can also supply power to the memory interface 37 and flash memory 26 in addition to the parts of the RFID tag 27. As a result, even when the receipt printer 10 power is off, the tag control unit 34 can write data to the flash memory 26 based on the received data, and can access the flash memory 26 and retrieve data stored in the flash memory 26.

The manufacturer M stores the following data to a specific storage area in the flash memory 26 of the receipt printer 10.

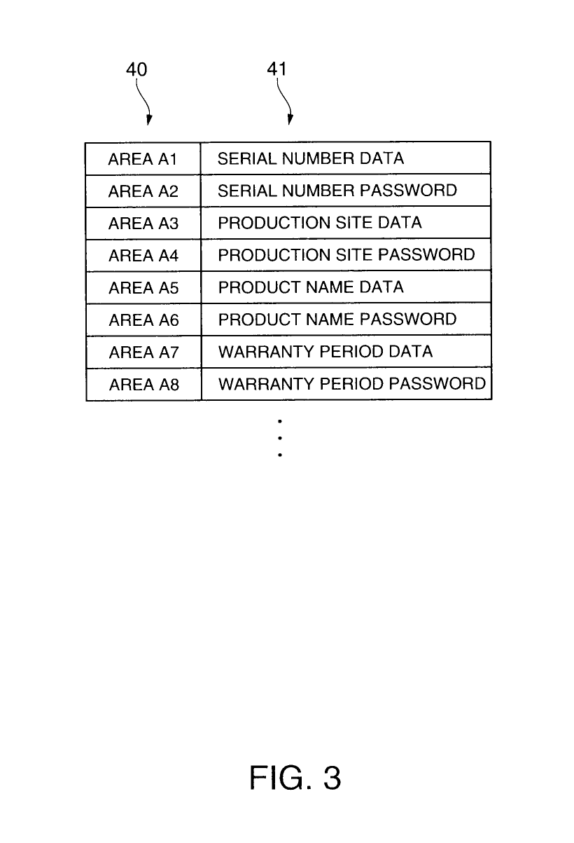

FIG. 3 shows a list of data stored in the flash memory 26 by the manufacturer M in the manufacturing and shipping step S1.

Names assigned for convenience to storage areas in flash memory 26 are shown in the address field 40 in FIG. 3, and names assigned for convenience to the data stored at the corresponding addresses are shown in the data field 41.

As shown in FIG. 3, serial number data denoting the serial number uniquely assigned to each receipt printer 10 is stored in area A1 in flash memory 26. Note that area A1 denotes a storage area formed by segmenting the total storage space of the flash memory 26, and is uniquely defined by the start address indicating the position in the flash memory 26 storage space from which data is stored in area A1. The other storage areas are similarly identified.

A serial number password indicating the password required to rewrite the serial number data stored in area A1 is stored in area A2. This serial number password is known only to the manufacturer M.

The receipt printer 10 according to this embodiment of the invention enables rewriting the serial number data stored in area A1 by operating switches on the input unit 22 while reading information displayed on the display panel of the display unit 23. The serial number data stored in area A1 can also be overwritten using a user interface provided by a dedicated application downloaded by the read/write-capable cell phone 30 described below. Input of the serial number password is requested when overwriting the serial number data stored in area A1, and the serial number data can be overwritten only when the input serial number password matches the serial number password stored in area A2. This prevents someone other than the manufacturer M from illegally overwriting the serial number data.

Production site data indicating where the receipt printer 10 was manufactured is stored in area A3, and a production site password that is required to change the production site data stored in area A3 is stored in area A4.

Product name data indicating the product name of the receipt printer 10 is stored in area A5, and a product name password that is required to change the product name stored in area A5 is stored in area A6.

Warranty period data indicating the warranty period defined by the manufacturer M (such as three years) is stored as the receipt printer 10 warranty period in area A7, and a warranty period password that is required to change the warranty period data stored in area A7 is stored in area A8.

By protecting the production site data, product name data, and warranty period data with a password similarly to the serial number data, illegally overwriting these values by someone other than the manufacturer M is prevented.

This serial number data, production site data, product name data, and warranty period data are data that are set by the manufacturer M, and are data that are required to identify the receipt printer 10 and determine the receipt printer 10 production and shipping history when maintaining, repairing, or providing other product support for the receipt printer 10.

During the manufacturing and shipping step S1 the manufacturer M manufactures receipt printers 10 configured as described above, packs the manufactured receipt printers 10 in dedicated cartons 45, and ships the receipt printers 10 to the system integrator SI. The cartons 45 storing the receipt printers 10 are transported to a warehouse operated by the system integrator SI, for example.

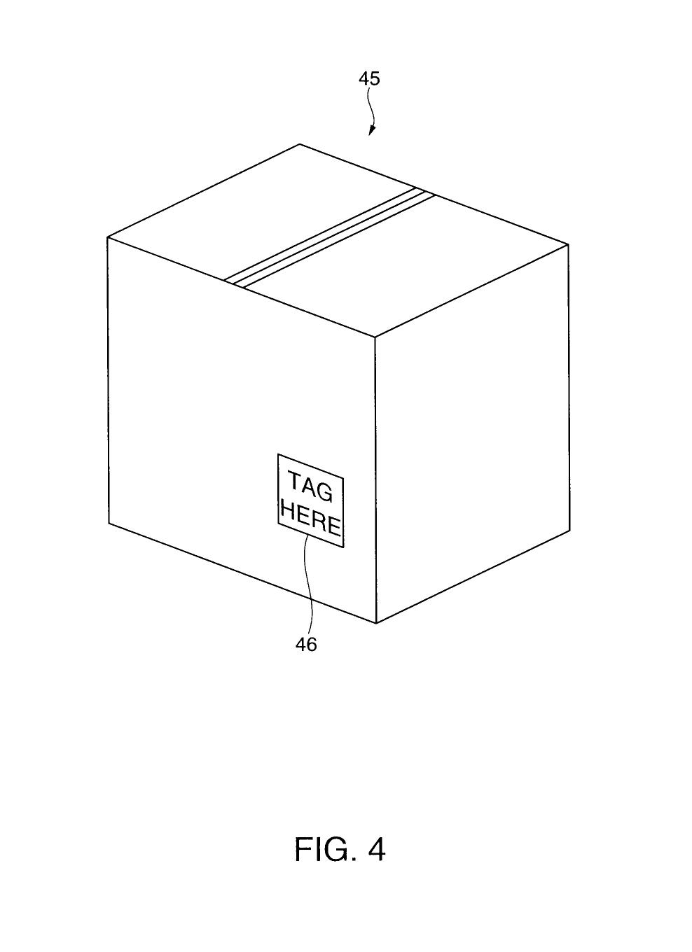

FIG. 4 shows a carton 45 in which a receipt printer 10 is packaged.

As shown in FIG. 4, a tag mark 46 is provided on one side of the rectangular carton 45.

The tag mark 46 is applied to the position (a position near the antenna 31) corresponding to the location of the antenna 31 of the RFID tag 27 disposed to the receipt printer 10 stored in the carton 45. The tag mark 46 is disposed to a position on the carton 45 previously determined by tests and simulation to enable reliable short-range wireless communication between the read/write-capable cell phone 30 and the RFID tag 27 when the read/write-capable cell phone 30 described below is set near the tag mark 46. As a result, reliable short-range wireless communication between the read/write-capable cell phone 30 and the RFID tag 27 is enabled by bringing the read/write-capable cell phone 30 close to the tag mark 46.

Note that the receipt printers 10 are mass produced by the manufacturer M, and the position of the antenna 31 on the receipt printer 10 is the same in all receipt printers 10. Therefore, assuming that the orientation of the receipt printers 10 in the cartons 45 is always the same, the location of the tag mark 46 is also the same, and the cartons 45 can also be mass produced.

The preparation step S2 that follows the manufacturing and shipping step S1 is described next.

A specific process is applied to the receipt printers 10 stored in the cartons 45 by the system integrator SI during the preparation step S2.

Note that a system integrator SI as used herein is not limited to a system integrator SI that operates as a separate entity, and for convenience herein means the person in the system integrator SI that does the actual work.

The system integrator SI first prepares the read/write-capable cell phone 30 in the preparation step S2.

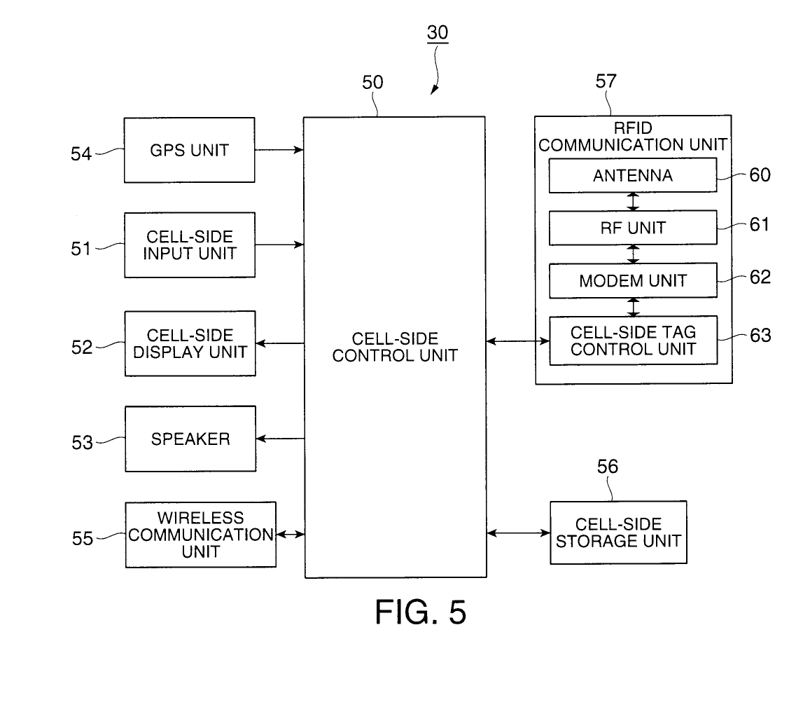

FIG. 5 is a function block diagram of the read/write-capable cell phone 30.

As shown in FIG. 5, the read/write-capable cell phone 30 is a cell phone having a function for reading and writing data in the RFID tag 27 by means of short-range wireless communication with the RFID tag 27 of the receipt printer 10, and includes a cell-side control unit 50, a cell-side input unit 51, a cell-side display unit 52, a speaker 53, a GPS unit 54, a wireless communication unit 55, a cell-side storage unit 56, and an RFID communication unit 57.

The cell-side control unit 50 centrally controls parts of the read/write-capable cell phone 30, and includes a CPU, ROM, RAM, and other peripheral circuits.

The cell-side input unit 51 detects user operation of operating switches disposed to the read/write-capable cell phone 30, and outputs to the cell-side control unit 50.

The cell-side display unit 52 has an LCD panel, and displays information on the LCD panel as controlled by the cell-side control unit 50.

The speaker 53 outputs audio as controlled by the cell-side control unit 50.

The GPS unit 54 receives GPS signals sent from GPS satellites by means of a GPS antenna or receiver, and calculates and outputs the position of the read/write-capable cell phone 30 from the GPS signals carried in the GPS signal to the cell-side control unit 50.

The wireless communication unit 55 communicates wirelessly according to a defined specification with a wireless base station 58 (FIG. 1) in the reception area where the read/write-capable cell phone 30 is located as controlled by the cell-side control unit 50. The wireless base station 58 is connected to a communication network such as the Internet or a mobile communication network 11 (FIG. 1), and the read/write-capable cell phone 30 can communicate data with the manufacturer-side server 12 through the communication network 11.

The cell-side storage unit 56 includes a nonvolatile storage device, and stores data nonvolatilely.

The RFID communication unit 57 communicates with the RFID tag 27 of the receipt printer 10 by means of short-range wireless communication conforming to a NFC standard, and includes an antenna 60, RF unit 61, modem unit 62, and cell-side tag control unit 63.

The antenna 60 functions as an antenna for data communicate.

The RF unit 61 communicates data with the RFID tag 27 through the antenna 60, and when sending data sends a carrier wave transmitting power and the transmitted data through the antenna 60 as an RF signal to the RFID tag 27. When receiving data, the RF unit 61 outputs signals received from the RFID tag 27 through the antenna 60 to the modem unit 62.

The modem unit 62 modulates and demodulates the communication data, modulates and outputs the transmission data to the RF unit 61 during data transmission, and during data reception demodulates the received data and outputs to the cell-side tag control unit 63 based on the signals received form the RF unit 61.

The cell-side tag control unit 63 centrally controls RFID communication unit 57 operation. As controlled by the cell-side control unit 50, the cell-side tag control unit 63 encodes and outputs the transmission data to the modem unit 62 during data transmission, and during data reception decodes and outputs the received data input from the modem unit 62 to the cell-side control unit 50.

The functions of the RFID communication unit 57 can be added to existing cell phones by installing an SD card with an RFID communication function in the optional card slot of the cell phone for installing external memory such as an SD card. In this case, the cell-side storage unit 56 shown in FIG. 5 can also use the storage capacity of the added SD card.

In the preparation step S2 the system integrator SI first writes specific data to the flash memory 26 of the receipt printer 10 using the configured read/write-capable cell phone 30.

More specifically, the system integrator SI first starts an application previously downloaded from the manufacturer-side server 12 maintained by the manufacturer M, and displays a data input screen 65 on the display panel of the cell-side display unit 52. Note that the manufacturer M may previously communicate the URL of the manufacturer-side server 12 site to the system integrator SI. This URL may also be recorded on the carton 45, or a 2D barcode containing the URL may be printed in a form readable by the read/write-capable cell phone 30 on the carton 45.

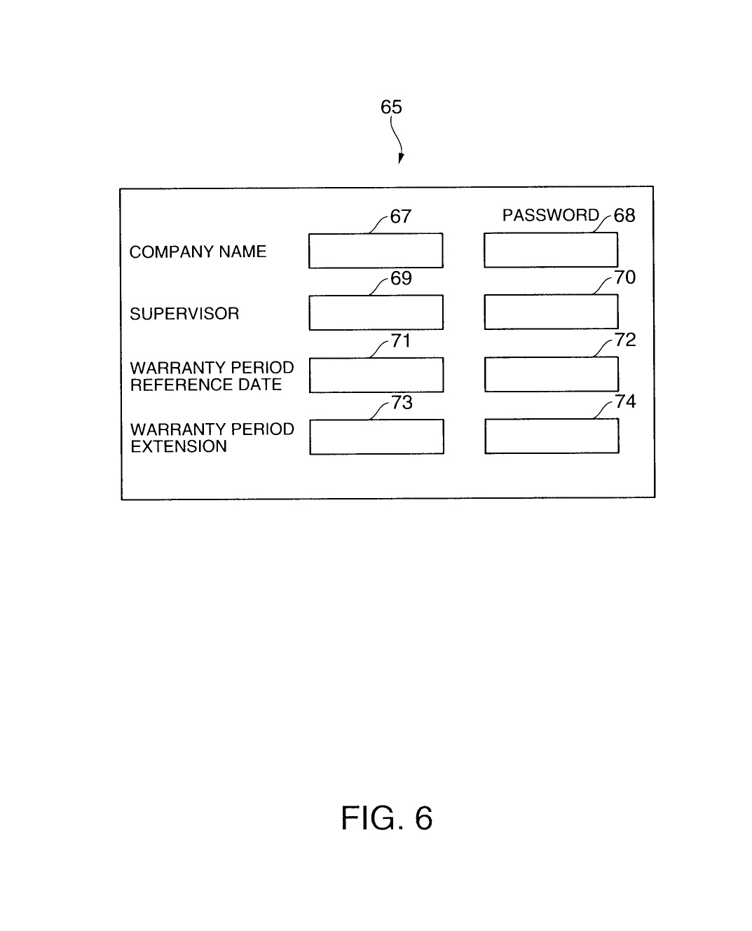

FIG. 6 shows an example of the data input screen 65.

The company name of the system integrator SI that is responsible for installing the POS system is input to a company name field 67. The password required to overwrite the company name data after the company name data indicating the company name input to the company name field 67 is stored in a specific storage area in flash memory 26 as described in detail below is input to the company name password field 68 corresponding to the company name field 67.

The name of the supervisor for POS system construction is input to a supervisor field 69. The password required to overwrite the supervisor data after the supervisor data indicating the name of the supervisor input to the supervisor field 69 is stored in a specific storage area in flash memory 26 is input to the supervisor password field 70 corresponding to the supervisor field 69.

The reference date of the warranty period of the receipt printer 10 is input to the warranty period reference date field 71. The reference date of the warranty period is a date that is predefined as the date for calculating the warranty period. For example, if the day that the receipt printer 10 is delivered from the manufacturer M to the system integrator SI is defined as the date for calculating the warranty period, the delivery date is the reference date of the warranty period. For another example, if the day the receipt printer 10 is delivered to the retail store K is defined as the date for calculating the warranty period, that delivery date is the reference date of the warranty period. The password required to overwrite the warranty period reference date data after the warranty period reference date data indicating the warranty period reference date input to the warranty period reference date field 71 is stored in a specific storage area in flash memory 26 is input to the warranty period reference date password field 72 corresponding to the warranty period reference date field 71.

If the system integrator SI extends the warranty period defined by the manufacturer M, the number of days the warranty period is extended is input to the warranty period extension time field 73. At the responsibility and cost of the system integrator SI, the system integrator SI may offer a service that extends the warranty period, or offer a sales campaign that extends the warranty period, and the warranty period extension time field 73 is provided to accommodate such cases. The password required to overwrite the warranty period extension time data after the warranty period extension time data, which indicates the number of days the warranty period is extended, input to the warranty period extension time field 73 is stored in a specific storage area in flash memory 26 is input to the warranty period extension time password field 74 corresponding to the warranty period extension time field 73.

After entering data in the input fields of the data input screen 65, the system integrator SI operates an operating switch on the read/write-capable cell phone 30 and confirms the input.

The system integrator SI then operates a switch on the read/write-capable cell phone 30 to change the operating mode of the read/write-capable cell phone 30 to the data communication mode.

The data communication mode is an operating mode in which write command data and storage data transmission command data are sent from the read/write-capable cell phone 30 to the RFID tag 27 of the receipt printer 10 when the read/write-capable cell phone 30 is proximal to the RFID tag 27 of the receipt printer 10 and short-range wireless communication is possible.

The write command data is data for storing data denoting the information input to the input fields of the data input screen 65 to the respective specified storage areas previously reserved in the flash memory 26 of the receipt printer 10. After receiving the write command data, the tag control unit 34 stores the corresponding data in the specified storage areas in the flash memory 26 of the receipt printer 10 according to the content of the write command data. As described above, even when the receipt printer 10 is stored in a carton 45 and the receipt printer 10 power is off, power is supplied by the power supply unit 35 to the memory interface 37 and flash memory 26, and data can be written to flash memory 26 by the tag control unit 34.

The storage data transmission command data is data instructing transmission of the data (not including password data) stored in flash memory 26 to the read/write-capable cell phone 30 after data is written to flash memory 26 based on the write command data. After receiving the storage data transmission command data, the tag control unit 34 accesses the flash memory 26, acquires data stored in the storage areas of the flash memory 26, and sends the acquired data to the read/write-capable cell phone 30.

Note that generating and sending the write command data and storage data transmission command data are done by a function of the cell-side control unit 50 that runs the application.

In addition, when short-range wireless communication is enabled and communication of the data to be sent and received between the read/write-capable cell phone 30 and the receipt printer 10 is completed normally, an electronic sound acknowledging successful communication is output from the speaker 53 of the read/write-capable cell phone 30, and information indicating the same is displayed on the display panel of the cell-side display unit 52 of the read/write-capable cell phone 30.

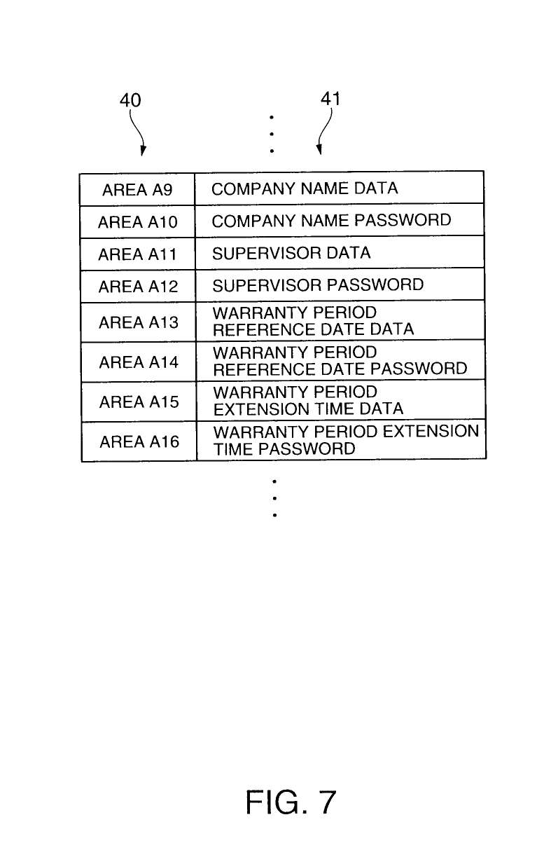

FIG. 7 is a table of the data stored to the storage areas after data is stored to the specified storage areas of flash memory 26 in the receipt printer 10 based on the write command data.

The data stored to area A1 to area A8 is described above with reference to FIG. 3, and is therefore omitted from FIG. 7.

As shown in FIG. 7, the company name data denoting the company name input to the company name field 67 of the data input screen 65 is stored to area A9 in flash memory 26, and the company name password denoting the password input to the company name password field 68 is stored to area A10.

In this embodiment of the invention a user interface provided by an application downloaded to the read/write-capable cell phone 30 can be used to overwrite the company name data stored in area A9. When the company name data stored in area A9 is overwritten, inputting the company name password is required, and the company name is overwritten only if the input company name password matches the company name password stored in area A10. This configuration can therefore prevent the company name data being illegally overwritten by someone other than the authorized system integrator SI that knows the correct password.

The supervisor data denoting the name of the supervisor input to the supervisor field 69 of the data input screen 65 is stored in area A11, and the supervisor password denoting the password input to the supervisor password field 70 is stored to area A12.

The warranty period reference date data denoting the warranty period reference date input to the warranty period reference date field 71 in the data input screen 65 is stored to area A13, and the warranty period reference date password denoting the password input to the warranty period reference date password field 72 is stored to area A14.

The warranty period extension time data denoting the number of days the warranty period was extended input to the warranty period extension time field 73 in the data input screen 65 is stored to area A15, and the warranty period extension time password denoting the password input to the warranty period extension time password field 74 is stored in area A16.

Similarly to the company name data, the supervisor data, warranty period reference date data, and warranty period extension time data are prevented from being illegally overwritten by someone other than the system integrator SI by password protection.

As described above, when the operating mode is set to the data communication mode, the storage data transmission command data is sent with the write command data from the read/write-capable cell phone 30 to the receipt printer 10. Based on this storage data transmission command data, the data stored in flash memory 26 (but not including password data) is sent from the RFID tag 27 to the read/write-capable cell phone 30. More specifically, the transmitted data is the serial number data (area A1), production site data (area A3), product name data (area A5), warranty period data (area A7), company name data (area A9), supervisor data (area A11), warranty period reference date data (area A13), and warranty period extension time data (area A15).

In addition, when the operating mode is set to the data communication mode, and the data stored to flash memory 26 is sent from the RFID tag 27 to the read/write-capable cell phone 30, the cell-side control unit 50 controls the wireless communication unit 55 to send the data received from the RFID tag 27 to the manufacturer-side server 12.

At this time the cell-side control unit 50 detects the current location based on input values from the GPS unit 54, and sends current location data denoting the detected current position to the manufacturer-side server 12.

Based on the received data, the manufacturer-side server 12 creates one record in the receipt printer management database 13.

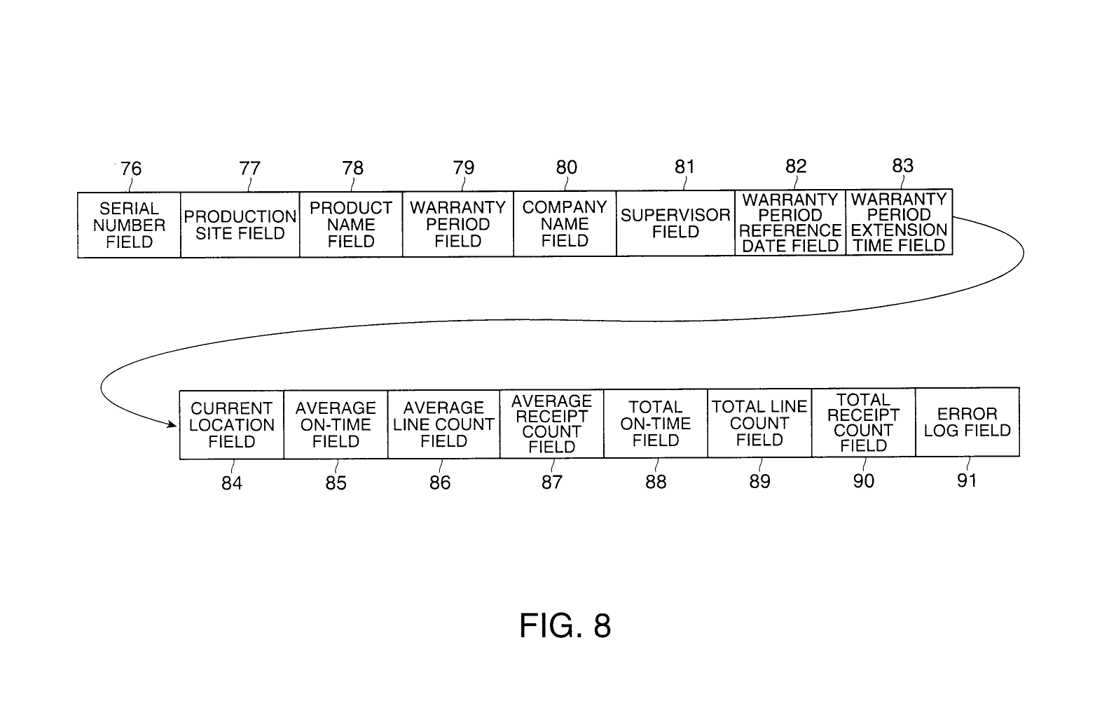

The fields in each record stored in the receipt printer management database 13 are schematically described in FIG. 8.

As shown in FIG. 8, each record of the receipt printer management database 13 includes: a serial number field 76 that stores the serial number data; a production site field 77 that stores production site data; a product name field 78 that stores product name data; a warranty period field 79 that stores warranty period data; a company name field 80 that stores company name data; a supervisor field 81 that stores supervisor data; a warranty period reference date field 82 that stores warranty period reference date data; a warranty period extension time field 83 that stores warranty period extension time data; and a current location field 84 that stores the above-described current location data. Other fields are described below.

In this embodiment of the invention the warranty period reference date data and warranty period extension time data (data containing information about the product warranty) stored in flash memory 26 are sent from the read/write-capable cell phone 30 to the manufacturer-side server 12. The manufacturer-side server 12 stores this data for each receipt printer 10 in the receipt printer management database 13.

This enables the manufacturer-side server 12 to centrally manage product warranty related data for each receipt printer 10. More particularly, the product warranty related data stored in flash memory 26 in the receipt printer 10 is read by a read/write-capable cell phone 30 and sent to the manufacturer-side server 12 in this embodiment of the invention. Because the manufacturer-side server 12 manages product warranty related data for each receipt printer 10 in the receipt printer management database 13 based on the received data, the sameness of the content of data stored in receipt printer 10 flash memory 26 and the content of data managed by the manufacturer-side server 12 can be completely assured. It can therefore be assured that both the manufacturer M that administers the manufacturer-side server 12 and the system integrator SI that actually builds the POS system are aware of the same product warranty related data for each receipt printer 10.

The role of the data stored in flash memory 26 is described next.

As shown in FIG. 3, serial number data, production site data product name data, and warranty period data are respectively stored in flash memory 26 in areas A1 to A8. The information denoted by this data is required to identify a particular receipt printer 10 or to determine the production history of the receipt printer 10.

As shown in FIG. 7, the company name data, supervisor data, warranty period reference date data, and warranty period extension time data are respectively stored to areas A9 to A16 in flash memory 26. The information denoted by this data is required to determine the end date of the receipt printer 10 warranty period, and to determine the system integrator SI and the supervisor that handled integrating the POS system that uses the receipt printer 10.

The information denoted by the data stored in flash memory 26 is the information that is conventionally recorded on paper warranty cards.

As a result, the data stored in flash memory 26 in this embodiment of the invention functions as a substitute for a conventional paper warranty card. A paper warranty card is therefore not produced in this embodiment of the invention.

In addition, because the serial number data, production site data, product name data, and warranty period data are password protected so that they cannot be illegally changed by someone other than the manufacturer M, the reliability of their content is also assured and maintained. Likewise, because the company name data, supervisor data, warranty period reference date data, and warranty period extension time data are password protected so that they cannot be illegally rewritten by someone other than the system integrator SI, the reliability of their content is also assured and maintained.

In the preparation step S2, the data stored in the flash memory 26 is written and read for every receipt printer 10 delivered from the manufacturer M.

More specifically, after opening the data input screen 65 and inputting information to the input fields, the system integrator SI sets the operating mode of the read/write-capable cell phone 30 to the data communication mode. The system integrator SI then holds the read/write-capable cell phone 30 near a carton 45 containing a receipt printer 10 so that the read/write-capable cell phone 30 and the RFID tag 27 of the receipt printer 10 communicate by short-range wireless communication, and repeats this process for all cartons 45.

Because a tag mark 46 is printed on each carton 45 as described above, the system integrator SI can reliably cause the read/write-capable cell phone 30 and the RFID tag 27 of the receipt printer 10 to communicate by short-range wireless communication by holding the read/write-capable cell phone 30 near the tag mark 46.

In addition, the data stored in flash memory 26 substitutes for a conventional paper warranty card, and writing the data to flash memory 26 in the receipt printer 10 is equivalent to writing the information denoted by the stored data on a conventional paper warranty card.

Conventional paper warranty cards are typically packed with the receipt printer 10 in the carton 45 in order to clearly identify the electronic device to which the warranty card belongs and to reduce the risk of the card being lost. This requires someone to open the carton 45, remove the card, and then write the information on the warranty card in order write the warranty information on the paper warranty card. However, some store K representatives do not want the cartons 45 to be opened due to a desire to ensure that the quality of the electronic device is not compromised, and require that the cartons 45 not be opened. In addition, the task of opening each carton 45, writing the information on the warranty card, and then resealing the carton 45 is bothersome and requires no small amount of time, and greater efficiency is therefore needed.

In contrast, this embodiment of the invention enables writing data to flash memory 26 (a process equivalent to the task of writing the information denoted by the stored data on a conventional paper warranty card) and reading data from flash memory 26 without opening the carton 45 by simply and easily holding the read/write-capable cell phone 30 near the tag mark 46 on the carton 45. This enables suitably meeting the customer desire that the carton 45 not be opened while also simplifying and shortening the amount of time required for the task of registering the warranty information.

There is also the risk that the wrong content will be recorded when information is conventionally written on a paper warranty card. However, the wrong data will not be written to flash memory 26 with this embodiment of the invention unless the wrong information is entered in to the input fields of the data input screen 65.

The set-up step S3 that follows the preparation step S2 is described next.

In the set-up step S3 the system integrator SI delivers the cartons 45 containing the receipt printers 10 to the retail store K. Because the cartons 45 have not been opened and there are no traces of having been opened, this helps make the store K representative feel secure and confident.

The system integrator SI then removes the receipt printers 10 from the cartons 45, places the receipt printers 10 in the appropriate locations, connects the receipt printers 10 to the power supply and to enable communication with other external devices, and constructs an environment for deploying a POS system. After constructing the environment for deploying a POS system, the system integrator SI then uses this environment to assemble the POS system.

Conventionally, the system integrator SI provides the retail store K with a paper warranty card for each receipt printer 10 when the receipt printers 10 are installed in the retail store K.

This means that the retail store K receiving the paper warranty cards must have a place to store the warranty cards, and must manage and store the warranty cards for the individual receipt printers 10, and this work is tedious.

In this case the system integrator SI must also dependably deliver all of the warranty cards to the retail store K after correctly filling in the information on each paper warranty card, and this is also tedious.

However, because the data stored in flash memory 26 in the receipt printer 10 substitutes for the paper warranty card and there is no need to deliver a paper warranty card to the customer in this embodiment of the invention, both the retail store K and the system integrator SI are relieved of the tedious tasks described above, and performance and convenience are improved for both the retail store K and the system integrator SI.

The retail store K representative can reference the data in flash memory 26 (that is, information equivalent to the information recorded on a conventional paper warranty card) after the POS system is constructed in the retail store K as follows. In this example one of the receipt printers 10 has failed and the retail store K representative wants to reference the information denoted by the data in flash memory 26 to determine the warranty period of that receipt printer 10.

The receipt printer 10 according to this embodiment of the invention displays information denoted by the data stored in flash memory 26 (not including password related data) in a list on the display panel, and stores a program for printing this list on roll paper in ROM or other storage device. The person trying to reference the information denoted by the data in flash memory 26 operates a switch disposed to the receipt printer 10 to display the information denoted by the data in flash memory 26 on the display panel or to print the information on roll paper.

When displaying the data on the display panel is selected, the control unit 20 accesses the flash memory 26, acquires the data, and presents the information denoted by the acquired data on the display panel. If printing the information on roll paper is selected, the control unit 20 accesses the flash memory 26, acquires the data, and controls the print engine 25 to print the information denoted by the acquired data on roll paper.

The invention thus enables the retail store K representative to see the information denoted by the data in flash memory 26 as desired by displaying the information on the display panel or printing it on roll paper. More particularly, in order to conventionally reference the warranty card for a particular receipt printer 10, the serial number recorded, for example, on the back of the receipt printer 10 must be retrieved, and the warranty card with the matching serial number must be retrieved from storage. However, this embodiment of the invention enables smoothly and easily retrieving the information denoted by the data in the flash memory 26 of a particular receipt printer 10 without performing such tasks.

Operation of the receipt printer 10 in the operating step S4 following configuration of the POS system in the retail store K is described next.

The operation of the warranty expiration warning unit 28 of the receipt printer 10 in the operating step S4 is described first.

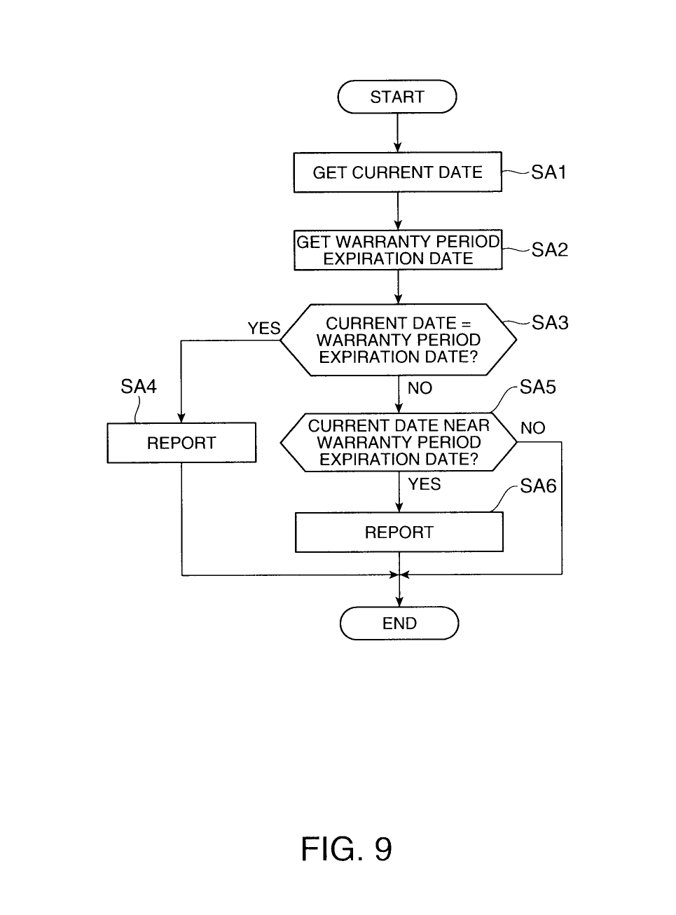

FIG. 9 is a flow chart showing the operation of the warranty expiration warning unit 28.

The function of this warranty expiration warning unit 28 is achieved by the cooperation of hardware and software components, such as by the CPU of the control unit 20 running a program stored in ROM.

The operation shown in the flow chart in FIG. 9 is executed when triggered by the receipt printer 10 power turning on or the current time reaching some preset time.

The warranty expiration warning unit 28 first gets the current date based on input from the RTC (step SA1).

Next, the warranty expiration warning unit 28 accesses the flash memory 26, retrieves the warranty period data, warranty period reference date data, and warranty period extension time data, and based on this data acquires the expiration date of the warranty period (step SA2).

The warranty expiration warning unit 28 then compares the current date acquired in step SA1 with the warranty period expiration date acquired in step SA2, and determines if the dates match (step SA3).

If the current date and the warranty period expiration date match (step SA3 returns Yes), the warranty expiration warning unit 28 controls the display unit 23 to display information indicating that today is the last day of the receipt printer 10 warranty period (step SA4).

If the current date and the warranty period expiration date do not match (step SA3 returns No), the warranty expiration warning unit 28 determines if the current date is chronologically before the warranty period expiration date and the number of days between the current date and the warranty period expiration date is less than a preset threshold value (step SA5).

If the difference in the number of days between the current date and the warranty period expiration date is less than the preset threshold value, the warranty expiration warning unit 28 controls the display unit 23 to display information denoting the warranty period expiration date and a message indicating that the warranty period expiration date is near (step SA6).

After the POS system is constructed as described above, each receipt printer 10 monitors whether or not the current date equals the warranty period expiration date, and whether or not the warranty period expiration date is near, and automatically reports when the current date equals the warranty period expiration date or the warranty period expiration date is near. This enables the retail store K representative to easily and reliably know this information. More specifically, because each receipt printer 10 reports when the current date is the warranty period expiration date and when the warranty period expiration date is near, the retail store K representative can easily and reliably know this information for each receipt printer 10 when new receipt printers 10 are added to an existing POS system and the warranty period reference date is different for different receipt printers 10 without needing to perform the tedious task of the related art described above.

In the operating step S4 the control unit 20 of the receipt printer 10 also detects the operating status of the print engine 25 (drive unit) and the print mechanism that is controlled by the print engine 25, and writes data denoting the detected operating status to flash memory 26.

More specifically, after the POS system has been installed, the control unit 20 calculates the total time that the receipt printer 10 power is on each day, and based on the result calculates the average daily on-time (the average time the power is on per day). At a specified time, the control unit 20 stores this average on-time denoting this calculated time to a specific address in flash memory 26. Data already stored at that address is overwritten.

The control unit 20 also measures the cumulative time that the power is on after the POS system is installed, and at a specified time stores this total on-time data to a specific address in flash memory 26. Data already stored at that address is overwritten.

The control unit 20 also counts the number of lines printed by the receipt printer 10 and the number of receipts issued by the receipt printer 10, and writes the average line count data denoting the average number of lines printed per day, and the average receipt count data denoting the average number of receipts printed per day, to specific addresses in flash memory 26 at respective specified times. Data already stored at that address is overwritten.

The control unit 20 also counts the total number of lines printed by the receipt printer 10 and the total number of receipts issued by the receipt printer 10 after the POS system was configured, and stores this total line count data and total receipt count data at specified times to specific addresses in flash memory 26.

The control unit 20 also stores error log data for an error log going back a specified time from the present to a specific address in flash memory 26 at a specified time. Data already stored at that address is overwritten.

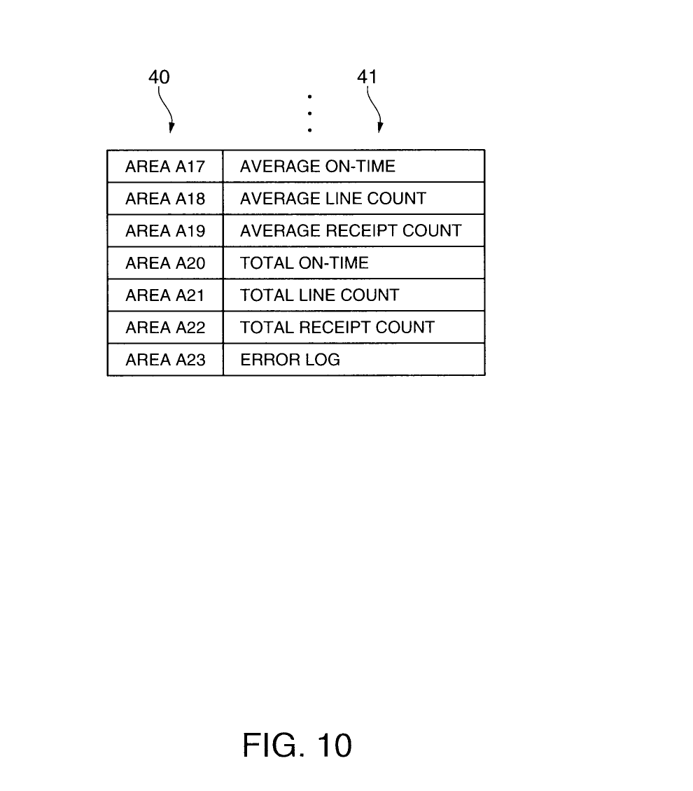

FIG. 10 shows a list of data stored in memory after the control unit 20 stores the data to the specified addresses in flash memory 26 in the operating step S4.

Note that the data stored to area A1 to area A16 is described above with reference to FIG. 3 and FIG. 7, and is therefore omitted from FIG. 10.

As shown in FIG. 10, the average on-time data described above is stored to area A17 in flash memory 26, the average line count data to area A18, the average receipt count data to area A19, the total on-time data is stored to area A20, the total line count data to area A21, the total receipt count data to area A22, and the error log data to area A23.

The data stored to area A17 to area A23 is information describing the operating status of the print engine 25 (drive unit).

As described above, data describing the operating status of the print engine 25, which is the drive unit, is stored in flash memory 26 in this embodiment of the invention.

As described above, data in flash memory 26 can be read and written from both the control unit 20 and RFID tag 27. As a result, the usability and reliability of data stored in flash memory 26 can be maintained, and data stored in the flash memory 26 can be read by the read/write-capable cell phone 30 by the easy, simple process of bringing an external read/write-capable cell phone 30 in proximity to the RFID tag 27.

During periodic maintenance by the system integrator SI, the data stored to area A17 to area A23 is read by the read/write-capable cell phone 30 and sent to the manufacturer-side server 12 together with other data (the data stored to area A1 to area A16, not including password data). At this time the cell-side control unit 50 of the read/write-capable cell phone 30 detects the current location based on input from the GPS unit 54, and also sends the current location data denoting the detected current location to the manufacturer-side server 12.

When this data is received, the manufacturer-side server 12 accesses the receipt printer management database 13, and based on the serial number data contained in the received data retrieves the record to be processed (the record corresponding to the receipt printer 10 for which data was read from flash memory 26) from among all of the records in the database. Next, based on the received data, the manufacturer-side server 12 stores the data to the appropriate fields in the retrieved record. Data already stored in any field is overwritten by the received data.

More specifically, referring to FIG. 8, the corresponding data in the data received from the read/write-capable cell phone 30 is stored (overwritten) to the serial number field 76, production site field 77, product name field 78, warranty period field 79, company name field 80, supervisor field 81, warranty period reference date field 82, and warranty period extension time field 83.

The current location data received from the read/write-capable cell phone 30 is stored (overwritten) to the current location field 84. As a result, current location data denoting the most recent location of the receipt printer 10 is stored to the current location field 84.

The average on-time data contained in the data received from the read/write-capable cell phone 30 is stored to the average on-time field 85, the average line count data is stored to the average line count field 86, the average receipt count data is stored to the average receipt count field 87, the total on-time data is stored to the total on-time field 88, the total line count data is stored to the total line count field 89, the total receipt count is stored to the total receipt count field 90, and the error log data is stored to the error log field 91.

The manufacturer-side server 12 uses data stored in the receipt printer management database 13 to analyze trends in the operating status of the receipt printer 10 and to analyze how the receipt printer 10 is used.

These analyses run by the receipt printer 10 are described more specifically below.

Note that a program containing the algorithms for performing the following analyses are stored on the manufacturer-side server 12, and the following analyses are done by the manufacturer-side server 12 running the program. More specifically, the following analyses are performed by the cooperation of hardware and software on the manufacturer-side server 12.

For example, the manufacturer-side server 12 calculates the average on-time (the total time the power is on per day) of all receipt printers 10 registered in a record in the receipt printer management database 13 based on the average on-time data stored in the average on-time field 85 of each record. The manufacturer-side server 12 then compares the daily on-time of the receipt printer 10 expected by the manufacturer M with the calculated average on-time of all receipt printers 10, detects the difference between the expected on-time and the actual on-time, and stores the detected difference. This detected difference is valuable information used by the manufacturer M when developing a receipt printer 10.

Based on the average line count data and the average receipt count data, the manufacturer-side server 12 similarly detects the difference between the daily line count and daily receipt count expected by the manufacturer M with the actual line count and receipt count.

This enables the manufacturer-side server 12 to analyze actual receipt printer 10 usage and output useful information based on the analysis.

The manufacturer-side server 12 also analyzes trends in errors that occurred based on the error log data stored in the error log field 91 of each record.

More specifically, the manufacturer-side server 12 detects the frequency (trend) of occurrence for each error, and detects if the frequency of each error exceeds a range allowed for the frequency of each error. If the frequency of a particular error is detected to exceed the allowable range, it is reported together with the content of the error and a warning is issued. This report and warning may be displayed on the display panel of the manufacturer-side server 12, for example. These reports and warnings also enable the manufacturer M to quickly learn when an error occurs at a frequency exceeding the allowed range, and to research the cause and execute an appropriate process such as issuing an alert related to the error based on this knowledge.

The frequency of errors per production site could also be detected using the production site data stored in the production site field 77. This enables detecting if errors occur at a frequency exceeding the allowed range for receipt printers 10 manufactured at a particular production site, and outputting valuable information related to determining why the error is occurring with such frequency to the manufacturer M.

The frequency of errors can also be detected for each system integrator SI that installs POS systems using the company name data stored in the company name field 80.

The manufacturer-side server 12 can thus analyze trends in receipt printer 10 operating status, including trends in error occurrence, and output useful information based on the results.

The manufacturer-side server 12 can also detect where the receipt printer 10 is installed based on the information denoting the current location data stored in the current location field 84. If the detected location is outside the area where the receipt printer 10 is expected to be, the receipt printer 10 may be located away from the expected location due to theft or other reason, and this can be reported and a warning issued.

The manufacturer-side server 12 can also detect how many receipt printers 10 are located in particular areas based on information indicated by the current location data stored in the current location field 84 of each record, and analyze and store this receipt printer 10 distribution information. The results of this analysis are used as valuable information for receipt printer 10 marketing.

What happens in the operating step S4 when one receipt printer 10 fails or some error occurs is described next.

When this happens the retail store K representative contacts the system integrator SI that installed the POS system, and reports that the receipt printer 10 failed or an error occurred. If the retail store K representative wants to know when contacting the system integrator SI if the current date is within the warranty period, the representative can operate the switch disposed to the receipt printer 10 that failed to display information denoted by the data stored in flash memory 26 on the display panel or print the information on roll paper as described above, and thereby easily and reliably know if the current date is within the warranty period.

After being notified by the retail store K, the system integrator SI visits the retail store K. The system integrator SI then operates a switch disposed to the read/write-capable cell phone 30 and sets the operating mode of the read/write-capable cell phone 30 to the data recovery mode.

This data recovery mode is an operating mode in which when the read/write-capable cell phone 30 is brought into proximity with the RFID tag 27 of the receipt printer 10 and short-range wireless communication is enabled, the data stored in the flash memory 26 is sent to the read/write-capable cell phone 30 from the RFID tag 27 of the receipt printer 10.

The receipt printer 10 failure in this example is a failure of the receipt printer 10 power turning on due to a problem in the power supply system, for example. As described above, the RFID tag 27 of the receipt printer 10 in this embodiment of the invention uses a power transmission carrier signal received from the read/write-capable cell phone 30, and can read/write data to the flash memory 26 even when receipt printer 10 power is off. As a result, data stored in flash memory 26 can be reliably sent from the RFID tag 27 to the read/write-capable cell phone 30 by setting the read/write-capable cell phone 30 close to the RFID tag 27 after setting the operating mode to the data recovery mode.

When data is sent from the RFID tag 27 to the read/write-capable cell phone 30 in the data recovery mode, the cell-side control unit 50 of the read/write-capable cell phone 30 controls the cell-side display unit 52 and displays the information denoted by the received data on the display panel. This information includes the warranty period, warranty period reference date, warranty period extension time, and the error log.

Because the warranty period, warranty period reference date, and warranty period extension time are displayed on the display panel of the read/write-capable cell phone 30, the system integrator SI can easily determine based on this information if the printer is currently still under warranty.

Furthermore, because the error log is also displayed on the display panel of the read/write-capable cell phone 30, the system integrator SI can refer to the content of the error log presented on the display panel, and efficiently determine the cause of the problem or error.

The system integrator SI can also use the following services provided by the manufacturer-side server 12 in this embodiment of the invention when repairing the receipt printer 10.

More specifically, an application providing a user interface for sending error log data to the manufacturer-side server 12 is provided by the manufacturer M, and the application is downloaded in advance by the system integrator SI to the read/write-capable cell phone 30.

Using the user interface rendered by a function of this application, the system integrator SI issues a command to send the error log data received from the RFID tag 27 to the manufacturer-side server 12.

Triggered by this command, the cell-side control unit 50 controls the wireless communication unit 55 and sends the error log data to the manufacturer-side server 12 using a function of the application.

The manufacturer-side server 12 stores previously received error log data correlated to data describing information related to the procedure to use when handling the error indicated by the content of the error log data. When the error log is received from the read/write-capable cell phone 30, the manufacturer-side server 12 analyzes the received error log data, and determines if the previously received error log data contains error log data with the same or similar content as the received error log data. The manufacturer-side server 12 then retrieves the data describing the information related to the procedure to use when handling the error indicated by the content of the error log data, and sends the acquired data to the read/write-capable cell phone 30.

Based on the data related to the procedure received by the read/write-capable cell phone 30 from the manufacturer-side server 12, the system integrator SI displays the information related to the procedure on the display panel, and using this information appropriately repairs the receipt printer 10.

A manual describing error handling procedures could also be prepared for each error indicated by the content of the error log data and stored as digital data, and the manufacturer-side server 12 could retrieve the digital data related to the received error log data from the manual and send it to the read/write-capable cell phone 30.

Errors that prevent the error log from being normally written to flash memory 26 can also occur in the receipt printer 10. In this event the system integrator SI can use the following service provided by the manufacturer-side server 12.

An application that provides a user interface for inputting the conditions in which an error occurred using a yes/no query method or selection method is provided for this service by the manufacturer M, and the system integrator SI downloads this application to the read/write-capable cell phone 30 in advance.

If error conditions are entered using a yes/no query method or selection method, the error conditions are input by responding selectively to questions related to error conditions, such as “Does the power turn on, Yes or No?”

The system integrator SI then uses the user interface provided by a function of the application to input the error conditions and confirm the input content.

Triggered by this operation, the cell-side control unit 50 controls the wireless communication unit 55 and sends data denoting the input content to the manufacturer-side server 12 using a function of the application.

Combinations of answers to the queries and data denoting information related to the error handling procedure are linked and stored based on previously received data. When data is received from the read/write-capable cell phone 30, the manufacturer-side server 12 retrieves data denoting information related to the procedure for handling the error indicated by the received data based on the received data, and sends the retrieved data to the read/write-capable cell phone 30.

Based on the data related to the error handling procedure received by the read/write-capable cell phone 30 from the manufacturer-side server 12, the system integrator SI displays the information related to the error handling procedure on the display panel, and using this information repairs the receipt printer 10 appropriately.

A manual describing the error handling procedures could also be prepared for each combination of answers to the questions and stored as digital data, and the manufacturer-side server 12 could retrieve the digital data from the manual according to the received data and send it to the read/write-capable cell phone 30.

As described above, a receipt printer 10 according to this embodiment of the invention is an electronic device that is shipped stored in a carton 45. An RFID tag 27 disposed in the case of the receipt printer 10 enables contactlessly reading and writing information by means of wireless communication with a read/write-capable cell phone 30, and the read/write-capable cell phone 30 can communicate with the RFID tag 27 to write and read information related to the product warranty from outside the carton 45.

As a result, the same information as the information recorded on a conventional paper warranty card can be recorded from the RFID tag 27 to rewritable flash memory 26, and the RFID tag 27 can be made function as a warranty card. Because the read/write-capable cell phone 30 can write warranty related information to flash memory 26 that can be read and written from the RFID tag 27 from outside the carton 45, there is no need to break the seal of the carton 45 containing the receipt printer 10 in order to remove the warranty card, and warranty-related information can be processed more efficiently than when the required information is manually written on a conventional paper warranty card.

A tag mark 46 is also recorded on a side of the carton 45 in this embodiment of the invention. This tag mark 46 is a mark that is recorded at a position identifying where the antenna 31 of the RFID tag 27 is located in the receipt printer 10 contained in the carton 45 (that is, near the antenna 31).

As a result, the system integrator SI or other person can smoothly and reliably cause the read/write-capable cell phone 30 and the RFID tag 27 of the receipt printer 10 to communicate by short-range wireless communication by simply bringing the read/write-capable cell phone 30 near the tag mark 46.

Overwriting product warranty-related data (warranty period reference date data, warranty period extension time data) that is written from the RFID tag 27 to the rewritable flash memory 26 is password protected in this embodiment of the invention.

This configuration prevents product warranty-related data that is written from the RFID tag 27 to the rewritable flash memory 26 from being illegally overwritten. In addition, by writing warranty-related data from the RFID tag 27 to the rewritable flash memory 26, the reliability of the data content can be assured when the RFID tag 27 is used as a warranty card.

The receipt printer 10 according to this embodiment of the invention can also report data related to the product warranty based on the data (warranty period reference date data, warranty period extension time data) related to the product warranty written to the rewritable flash memory 26 from the RFID tag 27. More specifically, the receipt printer 10 displays information described by the product warranty-related data that is written from the RFID tag 27 to the rewritable flash memory 26 on a display panel or prints it on roll paper.

Because product warranty related information can thus be reported, the user can retrieve the information as needed, thus improving user convenience.

The warranty expiration warning unit 28 of the receipt printer 10 according to this embodiment of the invention also reports when the end of the warranty period is approaching or that the warranty period has ended.

Because the approach of the end of the warranty period or the end of the warranty period is thus automatically reported, the user can reliably know that the end of the warranty period is approaching or that the warranty period has ended, thus improving user convenience.

One feature of the invention is that the RFID tag 27 is configured so that it can communicate with the read/write-capable cell phone 30 by short-range wireless communication conforming to an NFC standard.

NFC is a near field communication standard adopted by international standards organizations as a next-generation communication standard, and is widely compatible with other short-range communication technologies that are already in widespread use. Devices capable of short-range communication conforming to NFC standards are expected to become increasingly common.

Therefore, by rendering the RFID tag 27 capable of short-range wireless communication conforming to an NFC standard, particularly good usability and convenience can be achieved both now and in the future, and warranty related information can be processed using a contactless tag.

In addition, warranty period reference date data and warranty period extension time data (data describing information related to the product warranty) stored in flash memory 26 is also sent from the read/write-capable cell phone 30 to a manufacturer-side server 12 in this embodiment of the invention. This data is stored separately for each receipt printer 10 in a receipt printer management database 13 on the manufacturer-side server 12.

This enables the manufacturer-side server 12 to centrally manage product warranty related data for each receipt printer 10. More specifically, product warranty related data stored in flash memory 26 in the receipt printer 10 in this embodiment of the invention is read by the read/write-capable cell phone 30 and sent to the manufacturer-side server 12, and based on the received data the manufacturer-side server 12 manages product warranty related data for each receipt printer 10 in the receipt printer management database 13. The sameness of the content of data stored in receipt printer 10 flash memory 26 and the content of data managed by the manufacturer-side server 12 can therefore be completely assured, and it can therefore be assured that both the manufacturer M that administers the manufacturer-side server 12 and the system integrator SI that actually builds the POS system are aware of the same product warranty related data for each receipt printer 10.

It will be obvious to one with ordinary skill in the related art that the embodiment described above is only one embodiment of the invention, and can be modified and adapted as desired within the scope of the accompanying claims.

For example, the foregoing embodiment is described with reference to specific examples of the data stored in flash memory 26, but the data stored in flash memory 26 is not limited to that described above and may be increased or decreased as needed. For example, data relating to a product code or product model may also be stored, and data indicating the end date of the warranty period may be stored. This also applies to the data stored in the receipt printer management database 13.

This embodiment of the invention describes a receipt printer 10 as an example of an electronic device, but the electronic device of the invention is not limited to receipt printers 10. More specifically, the invention can be widely applied to any electronic device that is shipped packaged in a carton 45.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An electronic device comprising:
a contactless tag that can contactlessly read and write information by means of wireless communication with an external data processing terminal disposed in the electronic device case;
wherein the data processing terminal can read and write product warranty related data to the contactless tag.

2. The electronic device described in claim 1, wherein:
the electronic device is shipped in the packaging; and
a mark that is visible from the outside is recorded on the packaging at a position corresponding to the location of an antenna of the contactless tag in the case;
wherein the data processing terminal can read and write product warranty related data to the contact less tag from outside the packaging.

3. The electronic device described in claim 1, wherein:
overwriting the product warranty related data that is written to the contactless tag is protected by a password.

4. The electronic device described in claim 1, wherein:
information related to the product warranty can be reported based on the product warranty related data written to the contactless tag.

5. The electronic device described in claim 4, wherein:
the product warranty related data written to the contactless tag includes at least information related to a warranty period; and
the electronic device can report that the end of the warranty period is near or that the warranty period has ended based on the information related to the warranty period.

6. The electronic device described in claim 1, wherein:
the contactless tag can communicate with the data processing terminal by means of short-range wireless communication conforming to a Near Field Communication standard.

7. A data management system comprising:
an electronic device having a contactless tag disposed in the case of the electronic device;
a data processing terminal that can read and write information in the contactless tag disposed to the electronic device; and
a server device connected to the data processing terminal by a communication channel;
wherein the data processing terminal reads and writes product warranty related data to the contactless tag, and sends data read from the contactless tag to the server device; and
the server device stores information received from the data processing terminal.

8. The data management system described in claim 7, wherein:
the electronic device is stored in packaging; and
a mark that is visible from the outside is recorded on the packaging at a position corresponding to the location of an antenna of the contactless tag in the case.

9. The data management system described in claim 7, wherein:
the electronic device password protects overwriting the product warranty related data that is written to the contactless tag.

10. The data management system described in claim 7, wherein:
the electronic device can report product warranty related data based on the product warranty related data written to the contactless tag.

11. The data management system described in claim 7, wherein:
the server device stores error log information for errors that occur in the electronic device as error log data received from the data processing terminal, and analyzes error trends based on the error log data.

12. The data management system described in claim 11, wherein:
production site data for the electronic device is contained in information received from the data processing terminal, and the server device analyzes error trends by detecting error frequency per production site using the product site data and the error log data.

13. The data management system described in claim 11, wherein:
current location data for the electronic device is contained in information received from the data processing terminal, and the server device analyzes distribution of the electronic devices by detecting where the electronic devices are currently located using the current location data.

14. The data management system described in claim 11, wherein:
the server device identifies error content and issues a report or warning when the frequency of occurrence of an error exceeds an allowable range.

15. The data management system described in claim 11, wherein:
the server device stores previously error log data correlated to data describing information related to a procedure for handling an error identified by error log data content,
detects error log data having the same or similar content as the content of the received error log when an error log is received from the data processing terminal, and
sends to the data processing terminal information related a procedure for handling the error identified by the content of the error log data.
